(19) United States
(12) Patent Application Publication
(10) Pub. No.: US 2007/0171768 A1
(43) Pub. Date: Jul. 26, 2007

(54) Steeping device for producing a liquid mixture

(76) Inventor: Guy Dallaire, Montmagny (CA)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 10/590,396

(22) PCT Filed: Jan. 12, 2005
(86) PCT No.: PCT/CA05/00031

§ 371 Date: Aug. 21, 2006

Related U.S. Application Data
(60) Provisional application No. 60/546,939, filed on Feb. 24, 2004.

(51) Int. Cl. B01F 7/00

(52) U.S. Cl. 366/314

(57) ABSTRACT

The present invention relates to a steeping device for providing a liquid mixture. The steeping device (38, 138, 238) comprises a housing (27, 127, 227) defining a steeping chamber (44, 144) adapted to contain a steeping material therein and the housing (27, 127, 227) having an outlet aperture (78, 178) allowing the withdrawal of a fluid introduced into the steeping chamber (44, 144); and a one-way flow control member allowing the introduction of the fluid into the steeping chamber (44, 144) while preventing the introduced fluid to flow out from the steeping chamber (44, 144) therethrough.

### CROSS-REFERENCE TO RELATED APPLICATIONS

This application claims priority of U.S. provisional patent application 60/546,939 filed on Feb. 24, 2004, the specification of which is hereby incorporated by reference.

### BACKGROUND OF THE INVENTION

1) Field of the Invention

The invention relates to a steeping device adapted to contain a steeping material for producing a liquid mixture and, more particularly, to a container provided with a steeping device.

2) Description of the Prior Art

It is well known that drinking coffee, tea, or other infused or mixed liquid is a habit that extends from nearly every home to the work place. Preparing a cup of coffee, for example, requires a coffee making equipment which is designed from the more simple coffee pot to complicated coffee machines. This either takes too much time or relies on very expensive pieces of equipment.

The prior art is loaded with coffee machine equipments. However, the field of disposable cups which readily provide a cup of coffee, or another infusible material, is somewhat restricted and has not offered a device which gives complete satisfaction. For example, U.S. Pat. No. 2,915,176 suggests placing a wafer of a beverage concentrate at the bottom of the cup. U.S. Pat. No. 4,134,492 suggests adding a concentrate at the bottom of the cup and placing an expandable plastic film liner over it with the intention of piling a plurality of cups over one another. These two designs are of course not suitable for preparing a cup of good quality coffee. U.S. Pat. No. 4,306,492 discloses an apparatus for making a coffee beverage. The apparatus, which is provided with a cup, encloses a filter bag, filled with a portion of coffee. A bellows member is formed beneath the cup and separated by a perforated wall. The bellows member provides a pump-like action driving a current of water transversely through the filter bag.

Although the above described devices solves the problem to a certain extent, there is still a need for a device that allows to prepare rapidly several types of good quality beverages without having to manipulate bulk material.

### SUMMARY OF THE INVENTION

It is an object of the present invention to provide a device allowing to rapidly manufacture a liquid mixture without having to manage bulk material and incurring high maintenance expenses.

One aspect of the invention provides a container for providing a liquid mixture. The container comprises: a container member defining a charge holding space adapted to contain a fluid mixture, the charge holding space being opened for allowing to withdraw the liquid mixture, and a steeping device having a housing defining a steeping chamber in the housing. The steeping device has a one-way flow control member allowing the introduction of a fluid in the steeping chamber without allowing leakages of the introduced fluid. The steeping device has an outlet aperture adapted for allowing the fluid introduced in the steeping chamber to flow into the charge holding space.

Another aspect of the invention provides a steeping device for providing a liquid mixture. The steeping device comprises: a housing defining a steeping chamber adapted to contain a steeping material in the steeping chamber and the housing having an outlet aperture allowing the withdrawal of a fluid introduced into the steeping chamber; and a one-way flow control member allowing the introduction of the fluid into the steeping chamber while preventing the introduced fluid to flow out from the steeping chamber therethrough.

A further aspect of the invention provides a steeping device in combination with a container adapted to contain a liquid. The steeping device comprises: a housing defining a steeping chamber adapted to contain a steeping material and having an inlet aperture and an outlet aperture adapted to be in fluid communication with the steeping chamber, the housing being securable to the container, the outlet aperture being in fluid communication with the container when the steeping device is mounted to the container; and an inlet membrane covering the inlet aperture, the inlet membrane allowing the introduction of a fluid into the steeping chamber and preventing the introduced fluid from leaking outside the steeping chamber through the inlet aperture; and the container comprising an aperture allowing the withdrawal of the liquid from the container.

In this specification, the term “steeping” is intended to mean brewing, infusing, mixing, dissolving, soaking, suffuse, and the like wherein a fluid is bring in contact with a liquid or a solid.

### BRIEF DESCRIPTION OF THE DRAWINGS

Further features and advantages of the present invention will become apparent from the following detailed description, taken in combination with the appended drawings, in which:

FIG. 1 is a perspective view of a conventional beverage container;

FIG. 2 is a cross-sectional view of the container including a steeping device in accordance with an embodiment of the invention;

FIG. 3 is a cross sectional view of the steeping device shown in FIG. 2;

FIG. 4 is an exploded view of the steeping device shown in FIG. 2;

FIG. 5 is a cross-sectional view of the container including a steeping device in accordance with another embodiment of the invention;

FIG. 6 is an exploded cross-sectional view of the container including the steeping device shown in FIG. 5;

FIG. 7 is a perspective view of a mug having a steeping device mounted thereto in accordance with another embodiment of the invention;

FIG. 8 is an elevation view of the mug shown in FIG. 7, wherein the steeping device is removed from the mug; and

FIG. 9 is a cross-sectional view of the mug including the steeping device shown in FIG. 8.

It will be noted that throughout the appended drawings, like features are identified by like reference numerals.

### DETAILED DESCRIPTION OF THE PREFERRED EMBODIMENT

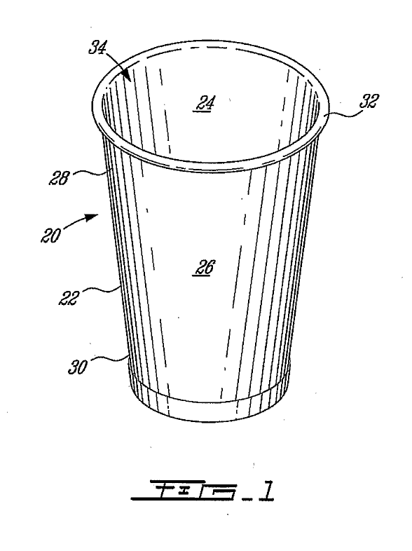

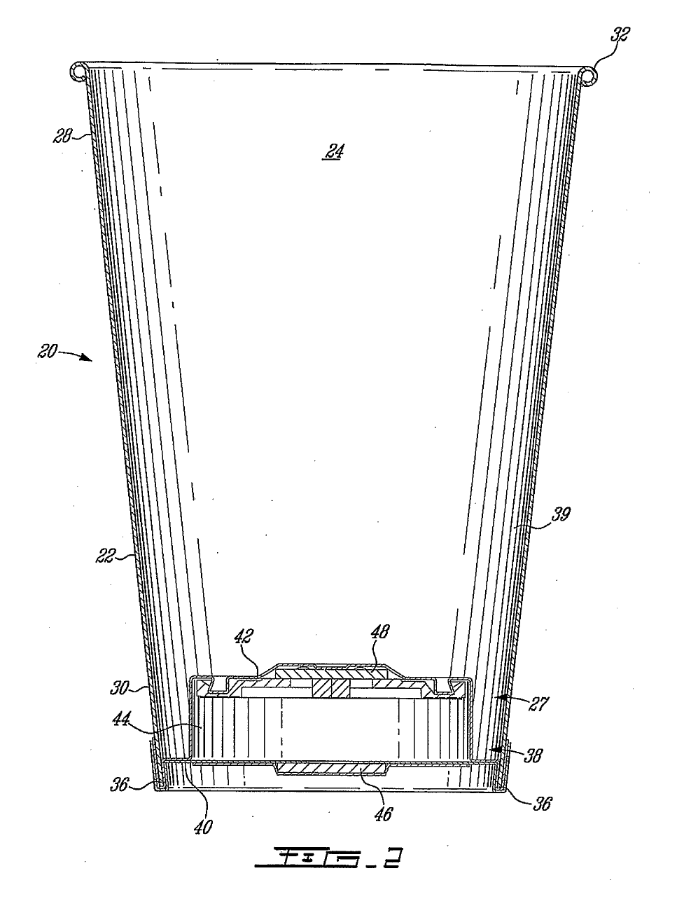

Referring now to the drawings and, more particularly, to FIG. 1, there is shown a container 20 having a frusto-conical cup shape with lateral walls 22 of standard construction having interior and exterior surfaces 24, 26. The lateral walls 22 have an upper portion 28 and a lower portion 30. The upper portion 28 of the lateral walls 22 terminates into a rim 32, that circumscribes a drinking aperture 34. The lower portion 30 of the lateral walls 22 terminates with an edge 36 (FIG. 2). One skilled in the art will appreciate that the shape of the container 20 can differ from the one illustrated in FIG. 1 and that the container 20 can include more than one drinking portion of a liquid mixture therein. Moreover, the shape of the drinking aperture 34 can differ from the one illustrated and the container 20 can be designed for other purposes than drinking.

Referring to FIGS. 2-4, it will be seen that a steeping device 38 in accordance with an embodiment is mounted to the lower portion 30 of the container 20 in place of the bottom wall thereof. The steeping device 38 has a housing 27 that includes a lower member 40 and an upper member 42 adapted to be sealingly mounted to the lower portion 30 of the lateral walls 22. Upper member 42 can also be mounted directly to the container 20, or any section of the steeping device 38 or the container 20. Lower member 40 and upper member 42 together define a steeping chamber 44 wherein a steeping material (not shown) can be disposed. As shown in FIG. 2, the steeping device 38 sealingly closes the bottom end of the container, thereby defining a charge holding space 39 above the steeping device 38 and within the volume confined by the sidewall 22 of the container.

The steeping device 38 also includes an input membrane 46 associated with lower member 40, that allows the introduction of a fluid into the steeping chamber 44 and an output membrane 48 that is associated with upper member 42 and permits the introduced fluid to exit from the steeping chamber 44 into the charge holding space 39 of the container 20. The input membrane 46 is made of a material that resumes its sealing properties after a thin object such as a needle has been inserted therein.

In a preferred embodiment, the input membrane 46 can be produced from silicone, latex, rubber material, thermoplastic elastomer, thermoset elastomer, elastomeric material, and the like. Similarly, the output membrane 48 can be made of a similar material than the input membrane 46, allowing the peripheral portion of the membrane 48 to be slightly deformed due to pressure applied thereon. However, other materials can be used as output membrane 48, as will be described in more details later.

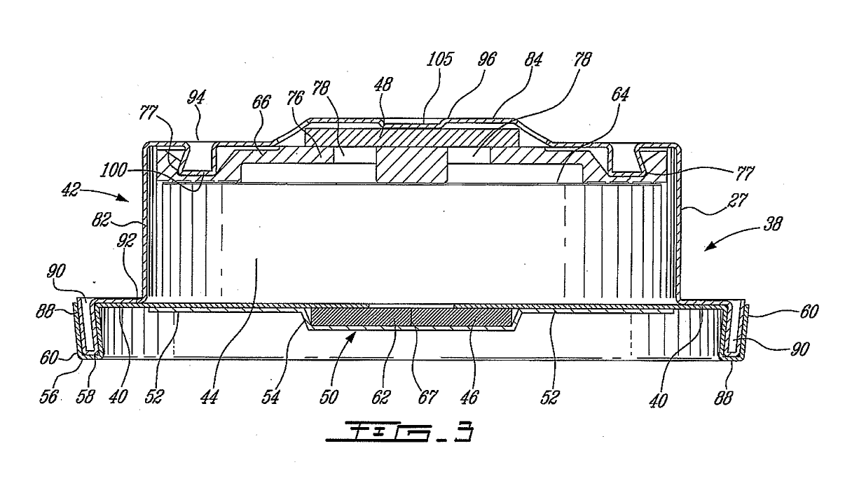

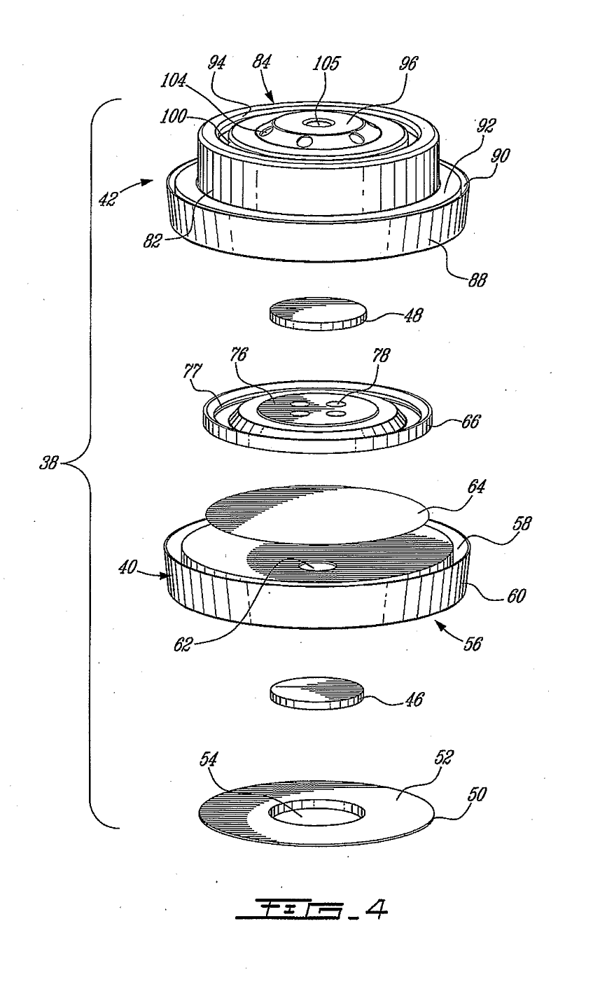

More specifically, referring simultaneously to FIGS. 3 and 4, it will be seen that the steeping device 38 includes a disc shaped support member 50 mounted to lower member 40 to hold the input membrane 46 thereto. Support member 50 has a lateral flange 52 and a recess portion 54 in which the input membrane 46 is seated. The lateral flange 52 of support member 50 is sealingly mounted to lower member 40 of the steeping device 38. Support member 50 can be made of at least one of a laminated aluminum foil, a plastic membrane, a laminated thermoplastic film, a plastic film and the like. Nevertheless any other material known to one skilled in the art can be used without departing from the scope of the present invention.

Lower member 40 has an engaging section 56 located on its periphery for sealingly mounting lower member 40 to the upper member 42, as will be described in more details below. The engaging section 56 includes an upwardly open groove 58 and an outward flange 60.

Lower member 40 also has an aperture 62 located above the input membrane 46. The aperture 62 allows the insertion of a fluid injection device therein through which the fluid flows inside the steeping chamber 44, as will be described in more details below.

The steeping device 38 can also include a filter paper 64 that prevents the steeping material disposed in the steeping chamber 44 to flow outside the steeping chamber 44 into the charge holding space 39 of the container 20. The filter paper 64 can be placed against an output membrane support 66. The output membrane support 66 has a central upper portion 76 and a peripheral engaging section 77 for engagement with upper member 42, as will be described in more details below. The central upper portion 76 has a plurality of apertures 78 that permit the fluid to flow outside the steeping chamber 44 into the charge holding space 39 of the container 20. The output membrane 48 rests against the central upper portion 76 of the paper filter support 66 and covers the apertures 78.

Upper member 42 of the steeping device 38 is in the form of a generally cylindrical member having downwardly extending lateral walls 82, merging with an outwardly flaring flange 92 that terminates into an engaging section 88, similar to the engaging section 56, defining an upwardly open groove 90. In addition upper member 42 has an upper surface 84 that is shaped to be engaged by the output membrane support 66 as will be explained in more detail below. The engaging section 88 is snugly inserted into the groove 58 and the edge 36 (FIG. 2) of the lateral walls 22 is engaged into the groove 90 so as to constitute a watertight assembly. In this manner, the steeping device 38 is sealingly mounted in the lower portion 30 (FIG. 2) of the container 20.

More particularly, the upper surface 84 includes an upper retaining portion 94 and a central stilted portion 96. The upper retaining portion 94 includes a peripheral U-shaped member 100 enabling to mount output membrane support 66 under upper member 42 as shown. The engaging section 77 of the output membrane support 66 is engaged into U-shaped member 100 of the upper surface 84. The central stilted portion 96 has a plurality of apertures 104 that permit the fluid to flow outside the steeping chamber 44 into the charge holding space 39 (FIG. 2) of the container 20. The central portion 96 is stilted for insertion of the output membrane 48 therein. As shown, the apertures 104 of the central stilted portion 96 are located above the output membrane 48. The central stilted portion 96 also has a recess 105 located in the middle thereof. The recess 105 applies pressure on the output membrane 48, prevents the deformation of the central portion of output membrane 48, and allows deformation of the peripheral outer portion of the output membrane 48. Therefore, when pressure is applied on the output membrane 48, as will be described in more details below, the central portion of the output membrane 48 remains in contact with the recess 105.

For producing a liquid mixture, a needle (not shown) or any other appropriate fluid injection device which can carry a fluid extends through support member 50, the input membrane 46 and the inside aperture 62 of lower member 40 and injects a predetermined amount of the fluid into the steeping chamber 44. The fluid gradually fills the steeping chamber 44 until the latter is full. At this point, the sides of the output membrane 48 are slightly separated from the output membrane support 66 due to the pressure applied on the output membrane 48 by the fluid and the latter can then flow into the charge holding space 39. The central portion of the output membrane 48 is not deformed and remains in contact with the recess 105 of the upper surface 84. Once the charge holding space 39 of the container 20 is full, the needle is retracted from support member 50 and the input membrane 46. The filled container 20 is ready to be used.

Once the filling operation is terminated, the input membrane 46 preferably immediately reacts to close and seal the opening made by the needle or the fluid injection device to prevent leakages of the introduced fluid. The pressure in the steeping chamber 44 returns to normal and the sides of the output membrane 48 can return to their original position, i.e. resting on the output membrane support 66 and, therefore, preventing liquid exchanges between the charge holding space 39 and the steeping chamber 44.

The input membrane 46 can be pre-pierced with a small slit 67 to facilitate the insertion of the fluid injection device. As it will be easily understood by one skilled in the art, the pre-piercing input membrane 46 does not reduce the sealing properties of this membrane.

The steeping device 38 is preferably disposable, but it can also be recyclable. Once the container 20 has been filled, support member 50 has a small hole therein, caused by the needle, showing that this container 20 has already been used.

During the production of the steeping device 38 in accordance with the above described embodiment, upper member 42, the output membrane 48, the output membrane support 66, and the filter paper 64 are first mounted to the container 20 by engaging the lower edge 36 into the groove 90. Then, a portion of the steeping material is suitably disposed in the steeping chamber 44 and lower member 40 including the input membrane 46 and support member 50 are then mounted to the container 20 by mounting the groove 58 over the engaging section 88 of upper member 42. Lower member 40 can be mounted immediately after filling the steeping chamber 44 with the steeping material, even if the steeping material is warm when inserted. When the pressure in the steeping chamber 44 becomes too high, for example, due to warm gases formed therein, the gas excess will be evacuated through the output membrane 48 as described earlier for the introduced fluid.

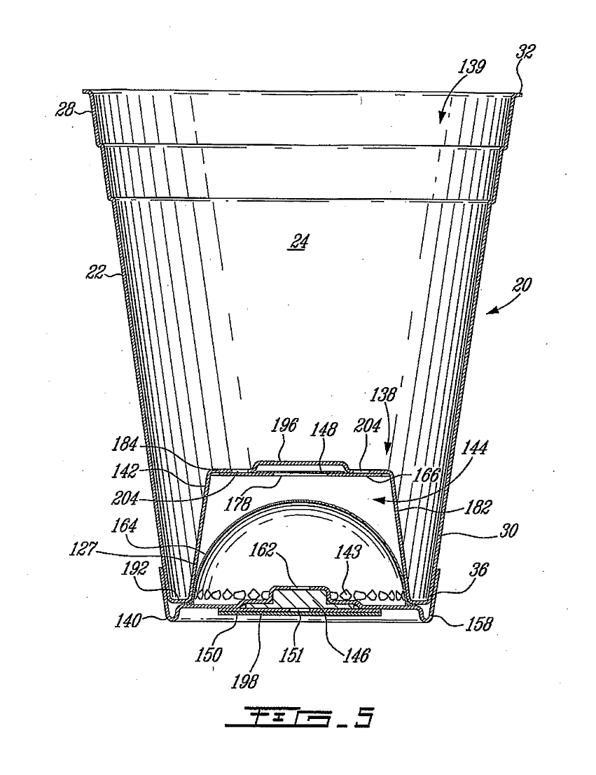

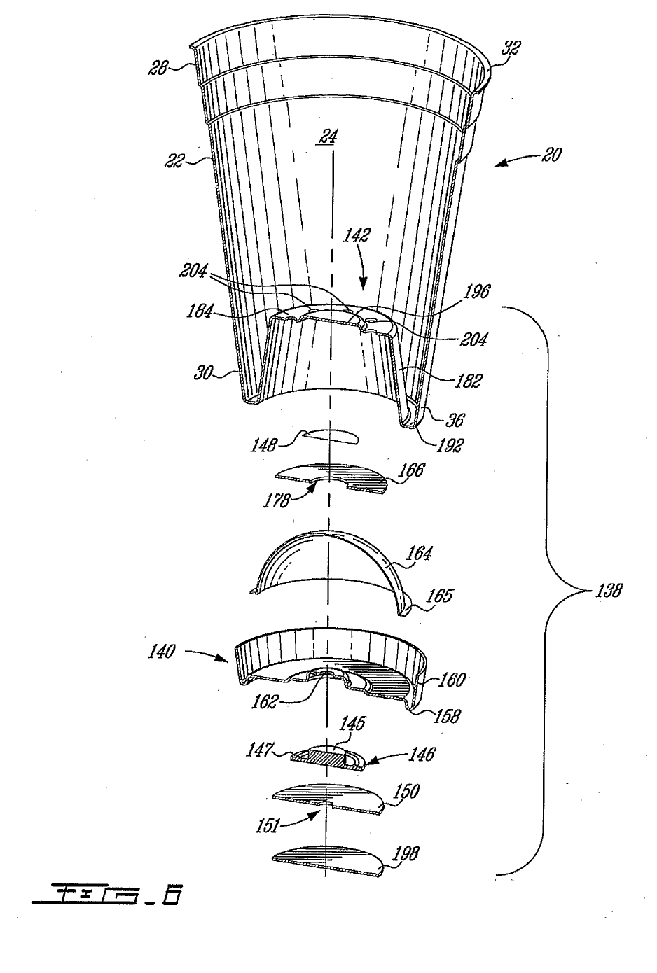

Referring to FIGS. 5 and 6, it will be seen another embodiment of a steeping device 138 mounted to the container 20. As for the steeping device 38, the steeping device 138 has a housing 127 with a lower member 140 and an upper member 142. Upper member 142 is one piece with the container 20 and they are joined at the edge 36 of the container 20. Upper member 142 and the container 20 define a charge holding space 139 above the steeping device 138 in which the liquid mixture can be contained. Lower member 140 is mounted to the lower portion 30 of the lateral walls 22 of the container 20.

Lower member 140 and upper member 142 together define a steeping chamber 144 in which the steeping material 143 is disposed. The steeping device 138 includes an input membrane 146, associated with lower member 140, that allows the introduction of the fluid into the steeping chamber 144 and an output membrane 148 allowing the introduced fluid to exit from the steeping chamber 144 into the charge holding space 139 of the container 20.

The input membrane 146 has a central section 145 with a surrounding thinner flange 147. The output membrane 148 is a thin film sealingly mounted to the steeping device 138, as will be described in more details below.

The steeping device 138 includes an annular support member 150 designed to mount the input membrane 146 to lower member 140. The support member 150 can have an aperture 151 therein allowing the passage of the fluid injection device therein to fill the steeping chamber 144 with the fluid.

Lower member 140 has a peripheral groove 158 and an outward flange 160 adapted for sealingly mounting lower member 140 to the container 20, the outward flange 160 abutting the lateral wall 22. Lower member 140 also has an aperture 162 located above the input membrane 146. The aperture 162 permits the insertion of the fluid injection device therein through which the fluid flows inside the steeping chamber 144.

The steeping device 138 can also include a filter paper 164 that prevents the steeping material 143 disposed in the steeping chamber 144 to flow outside the steeping chamber 144 into the charge holding space 139 of the container 20. The filter paper 164 has a hemispherical shape with a surrounding flange 165 inserted between lower and upper members 140, 142 to maintain the filter paper 164 in a predetermined position in the steeping chamber 144.

The steeping device 138 also includes an output membrane support 166, mounted to an upper surface 184 of upper member 142. The output membrane support 166 has an annular shape with a central aperture 178 that permit the introduced fluid to flow outside the steeping chamber 144 into the charge holding space 139 of the container 20.

The output membrane 148 is preferably sealingly mounted to the output membrane support 166. The output membrane 148 is preferably an aluminum foil laminated with a polymer that is sealingly mounted to the output membrane support 166 over the aperture 178. When sealingly mounted to the output membrane support 166, the output membrane 148 keeps the steeping material 143 fresh until the steeping device 138 is used. When the fluid is injected into the steeping chamber 144, the pressure on the output membrane 148 increases. When the pressure is over a certain level, the output membrane 148 delaminates, allowing the fluid to flow into the charge holding space 139.

For example, the output membrane 148 can be made from a laminated film which is peelable. The laminated film can be made of a support material such as an aluminum foil and/or a thermoplastic film and a sealing layer which is preferably made of a thermoplastic material. The support material of the laminated film is the mechanical support that offers the mechanical resistance to the film from tearing when peeled. The sealing layer provides an oxygen barrier to preserve the properties of the steeping material 143 inserted into the steeping chamber 144. The sealing layer seals the support material of the laminated film to the steeping device 138. One skilled in the art will appreciate that depending on the nature of the container material and the desired pressure to open the output membrane 148, the nature of the output membrane 148 can vary.

Upper member 142 of the steeping device 138 is in the form of a generally cylindrical member having lateral walls 182 downwardly extending from the upper surface 184, merging with an outwardly flaring flange 192 contiguous to the edge 36 of the container 20.

More particularly, the upper surface 184 includes a central stilted portion 196 and a plurality of apertures 204 on its periphery that permit the fluid to flow outside the steeping chamber 144 into the charge holding space 139 of the container 20. The central portion 196 is stilted for insertion of the output membrane 148 therein when delaminated.

The steeping device 138 can include a conservation seal 198 mounted below the support membrane 150 for preserving the properties of the steeping material 143.

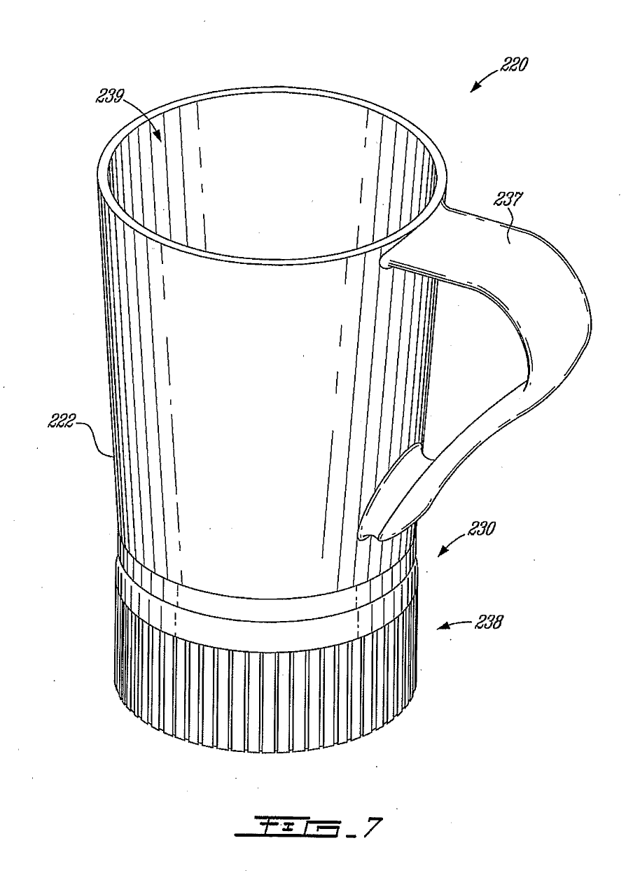

Referring now to FIGS. 7-9, there is shown another embodiment of a container 220, having the shape of a mug with a lateral wall 222, with a steeping device 238, mounted to a lower portion 230 of its lateral wall 222. The container 220 can be made of any material known to one skilled in art appropriate for mugs such as porcelain, stainless steel, plastic, ceramic, glass, and the like. The container 220 can include a handle 237 to facilitating its handling.

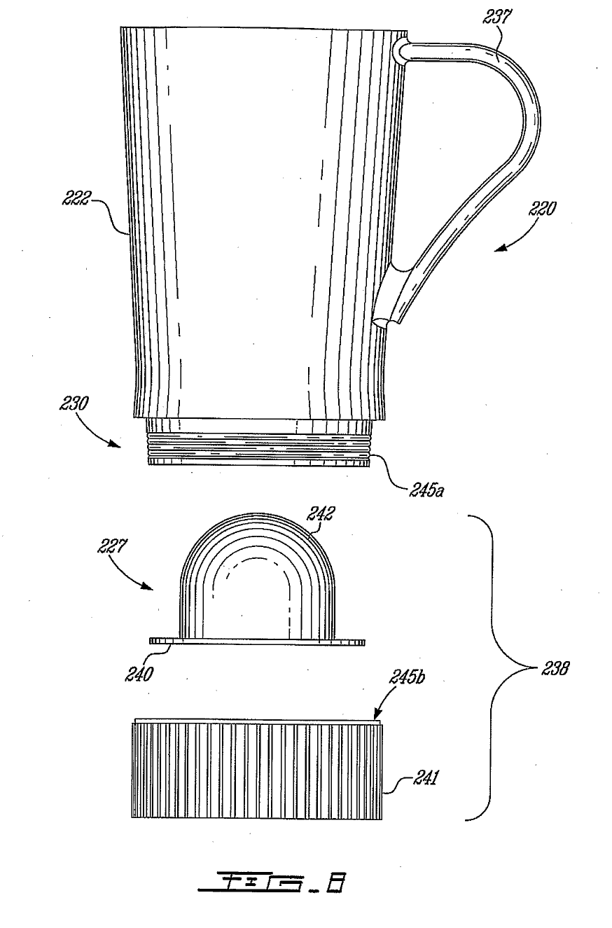

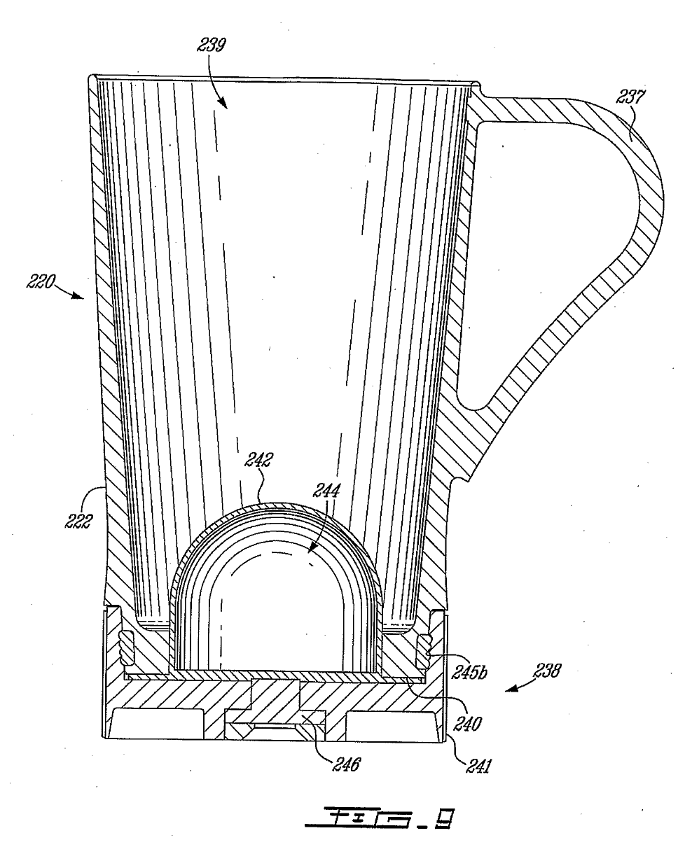

The steeping device 238 includes a base 241 adapted for mounting the latter to the container 220. The container 220 and the base 241 include cooperating engaging members 245a, 245b adapted to engage one another for mounting the base 241 to the container 220. On FIGS. 8 and 9, there is shown that cooperating engaging members 245a, 245b are cooperating threads allowing to screw the base 241 to the container 220. However, one skilled in the art will appreciate that other cooperating engaging members 245a, 245b can be used. Cooperating engaging members 245a, 245b preferably sealingly mount the base 241 to the container 220. The steeping device 238 and the container 220 define a charge holding space 239, above the steeping device 238, in which the liquid mixture can be contained.

As for the steeping devices 38, 138, the steeping device 238 has a housing 227 with a lower member 240 and an upper member 242, sealingly mounted to lower member 240, together defining a steeping chamber 244 in which the steeping material (not shown) is disposed. The steeping device 238 can include an output membrane allowing the introduced fluid to exit from the steeping chamber 244 into the charge holding space 239 of the container 20.

Except for the base 241, the steeping device 238 has a structure similar to the one of the steeping devices 38, 138 and will not be described in details.

The base 241 includes an input membrane 246 allowing the passage of the fluid injection device (not shown) into the steeping chamber 244. One skilled in the art will appreciate that the input membrane 246 that allows the introduction of a fluid into the steeping chamber 244 without leaking can either be mounted to the base 241 or the lower member 240.

For using the container 220, one dismounts the base 241 from the container 220, introduces the steeping chamber 244 as shown on FIG. 8, mounts the base 241 on the container 220, and introduces the fluid injection device into the input membrane 246 and the steeping chamber 244 until the container 220 is filled with the liquid mixture.

Once the container 220 is empty, the base 241 is dismounted from the container 220, the used steeping chamber 244 is removed, a new steeping chamber 244 is introduced and the base 241 is mounted to the container 220, which can be filled with a fluid. Therefore, the container 220 can be used several times with different steeping chambers 244 containing various steeping materials.

Several steeping materials can be disposed in the steeping chambers 44, 144, 244. For example, without being limitative, it can be solid steeping materials such as tea, coffee, chocolate powder, herbal tea, and the like. It can also be liquid steeping materials such as chocolate syrup and soft drink syrup. Neutraceutics and pharmaceutics products, which need to be diluted in a liquid before being used, can also be disposed within the steeping chambers 44, 144, 244. The steeping device 38, 138, 238 can be used to produce liquid mixtures that are not drinkable.

Several fluids can be inserted into the steeping devices 38, 138, 238. For example, without being limitative, it can be water, milk or gas. For example, gas and liquid can be introduced into the same steeping device 38, 138, 238 to produce a soft drink into the container 20, 220. Moreover, the temperature of the fluid can vary. For example, cold water can be introduced into the steeping device 38, 138, 238 to produce a soft drink while warm water can be introduced into the steeping device 38, 138, 238 to produce a coffee beverage.

The shape of the membranes 46, 48, 146, 148 can differ from the ones shown in the above described embodiments. Moreover, the method from mounting the steeping devices 38, 138, 238 to the container 20, 220 can also differ from the ones shown hereinabove.

The steeping device 38, 138, 238 might not include the output membrane 48, 148. If it includes the output membrane 48, 148, the output membrane 48, 148 is preferably sealingly mounted to the steeping device 38, 138, 238 to preserve the properties, such as the freshness, of the steeping material disposed therein.

Support member 50, 150 is preferably pre-pierced to facilitate the insertion of the fluid injection device into the steeping chamber 44, 144, 244. The steeping device 38, 138, 238 can also include a conservation seal, such as the conversation seal 198, which can be pre-pierced or not. If the conservation seal 198 is not pre-pierced, once pierced, it indicates that the steeping device 38, 138, 238 has already been used.

The filter paper 64, 164 is not mandatory to the steeping device 38, 138, 238. For example, if a liquid steeping material is disposed in the steeping chamber 44, 144, 244, there is no need to have the filter paper 64, 164. If the steeping device 38, 138, 238 includes the filter paper 64, 164, the latter is preferably mounted above the steeping material.

Moreover, the steeping chamber 44, 144, 244 can contain more than one steeping material. For example, a first steeping material can be disposed under the filter paper 64, 164 and a second steeping material can be disposed over the filter paper 64, 164. The first and the second steeping materials can be respectively coffee and chocolate, for example.

One skilled in the art will appreciate that the inlet membrane and the inlet aperture can be replaced by other one way flow control member that allows the introduction of a fluid in the steeping chamber without allowing leakages of the introduced fluid.

The steeping material can be directly disposed in the steeping chamber or can be disposed in a small bag (not shown) such as a tea bag.

The steeping device 38, 138, 238 is inexpensive and easy to manufacture, while allowing to obtain good quality liquid mixture in a fast and easy way.

The steeping device 38, 138, 238 does not require the purchase and management of bulk steeping material.

The steeping device 38, 138, 238 prevents the accumulation of garbage since disposal of the steeping device 38, 138, 238 is the responsibility of the user.

The steeping device 38, 138, 238 decreases the cost of making liquid mixtures and the maintenance cost. The variety of the products offered is unlimited.

The embodiments of the invention described above are intended to be exemplary only. The scope of the invention is therefore intended to be limited solely by the scope of the appended claims.

1. A container for providing a liquid mixture, the container comprising: a container member defining a charge holding space adapted to contain a fluid mixture, the charge holding space being opened for allowing to withdraw the liquid mixture, and a steeping device having a housing defining a steeping chamber therein, the steeping device having a one-way flow control member allowing the introduction of a fluid in the steeping chamber without allowing leakages of the introduced fluid, the steeping device having an outlet aperture adapted for allowing the fluid introduced in the steeping chamber to flow into the charge holding space.

2. A container as claimed in claim 1, wherein the one-way flow control member includes an inlet membrane.

3. A container as claimed in claim 2, wherein the inlet membrane includes a silicone membrane.

4. A container as claimed in claim 2, wherein the steeping device comprises an inlet aperture in fluid communication with the steeping chamber, the inlet aperture being covered by the inlet membrane.

5. A container as claimed in claim 2, wherein the inlet membrane is mounted to the housing.

6. (canceled)

7. A container as claimed in claim 1, comprising an outlet membrane covering the outlet aperture and allowing the introduced fluid to flow into the charge holding space when the steeping chamber is filled.

8. A container as claimed in claim 7, wherein the outlet membrane includes one of a silicone membrane and a laminated film membrane sealingly mounted to the steeping device.

9. A container as claimed in claim 1, wherein the container member comprises lateral walls with a lower portion and the steeping device is mounted to the lower portion of the lateral walls.

10. (canceled)

11. A container as claimed in claim 1, wherein the steeping device comprises a filter paper disposed in the steeping chamber.

12. (canceled)

13. A steeping device for providing a liquid mixture, comprising:
a housing defining a steeping chamber adapted to contain a steeping material therein and the housing having an outlet aperture allowing the withdrawal of a fluid introduced into the steeping chamber; and
a one-way flow control member allowing the introduction of the fluid into the steeping chamber while preventing the introduced fluid to flow out from the steeping chamber therethrough.

14. A steeping device as claimed in claim 13, comprising an outlet membrane covering the outlet aperture and allowing the introduced fluid to flow outside the steeping chamber when the steeping chamber is filled.

15. A steeping device as claimed in claim 14, wherein the outlet membrane includes one of a silicone membrane and a laminated film membrane sealingly mounted to the steeping device.

16. A steeping device as claimed in claim 13, comprises an engaging member adapted to engage a container member to mount the steeping device thereto.

17. A steeping device as claimed in claim 13, wherein the one-way flow control member includes an inlet membrane.

18. (canceled)

19. A steeping device as claimed in claim 17, wherein the steeping device comprises an inlet aperture in fluid communication with the steeping chamber, the inlet aperture being covered by the inlet membrane.

20. (canceled)

21. (canceled)

22. A steeping device as claimed in claim 13, wherein the steeping device comprises a filter paper disposed in the steeping chamber.

23. A steeping device in combination with a container adapted to contain a liquid therein, the steeping device comprising:
a housing defining a steeping chamber adapted to contain a steeping material and having an inlet aperture and an outlet aperture adapted to be in fluid communication with the steeping chamber, the housing being securable to the container, the outlet aperture being in fluid communication with the container when the steeping device is mounted thereto; and
an inlet membrane covering the inlet aperture, the inlet membrane allowing the introduction of a fluid into the steeping chamber and preventing the introduced fluid from leaking outside the steeping chamber through the inlet aperture; and
the container comprising an aperture allowing the withdrawal of the liquid from the container.

24. A combination as claimed in claim 23, comprising an outlet membrane covering the outlet aperture and allowing the introduced fluid to flow into the container when the steeping chamber is filled.

25. (canceled)

26. (canceled)

27. (canceled)

28. (canceled)

29. A combination as claimed in claim 23, wherein the inlet membrane is pre-pierced.

30. (canceled)

31. (canceled)

32. A combination as claimed in claim 23, wherein the steeping device comprises a filter paper disposed in the steeping chamber.

33. (canceled)
